(19) United States
(12) Patent Application Publication
(10) Pub. No.: US 2007/0220923 A1
(43) Pub. Date: Sep. 27, 2007

(54) Melter flow guide for glass fiberizing system

(76) Inventors: Anthony P. Oakleaf, New Albany, OH (US); Byron L. Bemis, Newark, OH (US)

Correspondence Address: OWENS CORNING, 2790 COLUMBUS ROAD, GRANVILLE, OH, 43023, US

(21) Appl. No.: 11/385,555

(22) Filed: Mar. 21, 2006

(51) Int. Cl. C03B 37/02; C03B 37/085; C03B 5/00; F27B 7/20

(52) U.S. Cl. 65/475; 65/495

(57) ABSTRACT

A glass fiberizing system includes a melter having a bottom wall with one or more openings through which molten glass flows. A bushing is located below the melter for containing a body of molten glass and for feeding molten glass to a fiberizing apparatus. A melter flow guide is positioned between the melter and the bushing. The melter flow guide has at least one guide wall positioned near the opening in the melter and extending into the body of molten glass in the bushing. The guide wall intercepts the molten glass exiting from the openings and prevents a free-fall of the molten glass into the body of glass in the bushing.

### TECHNICAL FIELD AND INDUSTRIAL APPLICABILITY

The present invention relates generally to a molten glass delivery system within a glass fiberizing system. The present invention has industrial applicability in a glass fiber production system to minimize or substantially prevent the formation of bubbles, or seeds, in the glass fibers.

### BACKGROUND OF THE INVENTION

In the production of glass fibers, a melter is frequently used where pre-refined glass is added at the top of the melter and heated to melting temperature to form molten glass. The molten glass moves downward within the melter and then flows into a bushing. The molten glass exits the bushing through a tip plate in the form of glass fibers or filaments. The tip plate is an apparatus having a plurality of very small orifices or tips through which molten glass streams are pulled. Thereafter, the glass streams are attenuated into fibers, coated with a sizing composition, and then gathered or wound into a package for later use.

In order to obtain proper attenuation of the glass fibers, it is important that the molten glass not have bubbles of air or gases entrained therein as the molten glass is pulled from the bushing tip plate.

In the past, the molten glass delivery systems allowed the glass to freely fall from the melter into the feed bushing or fiberizing bushing. The freely falling glass, however, allowed gas or air to be mixed into the glass, causing undesirable bubbles or seeds.

The Stevens U.S. Pat. No. 2,485,851 describes using heated vertical walls to heat the glass and then allowing the molten glass to fall into a drawing chamber.

One recently developed system by Owens Corning (described in the Higginbotham et al. U.S. Pat. No. 6,065,310, which is expressly incorporated herein by reference) has been used to remove the bubbles, or seeds, from molten glass by heating the molten glass as the molten glass freely falls through a series of screens.

However, it would be more beneficial to substantially prevent the formation of any bubbles or seeds in the glass, rather than to remove the bubbles once they have been formed in the molten glass.

### SUMMARY OF THE INVENTION

In accordance with the present invention, considerable improvement is realized in the glass filament production by installing a melter flow guide between a melter and a bushing.

In one aspect of the present invention a glass fiberizing system includes a melter having a bottom wall with one or more openings through which molten glass flows, and a bushing located below the melter for containing a body of molten glass and for feeding molten glass to a fiberizing apparatus.

A melter flow guide is positioned between the melter and the bushing. The melter flow guide has one or more guide walls positioned near the opening in the melter to the body of molten glass in the bushing. The guide wall intercepts the molten glass exiting from the openings, thus preventing a free-fall of the molten glass into the body of glass in the bushing.

The guide wall allows the molten glass from the melter to flow in an uninterrupted path from the opening in the melter into the body of molten glass in the bushing. In certain embodiments, the melter flow guide has first and second guide walls positioned at an acute angle with respect to a vertical plane extending through the melter flow guide. The melter flow guide minimizes the entrainment of air into the molten glass, thereby reducing or preventing the formation of bubbles, or seeds.

In another aspect, the present invention relates to a method for forming glass fibers. Glass is melted in a melter having a bottom wall with at least one opening through which molten glass flows. A bushing is provided below the melter for containing a body of molten glass and for feeding molten glass to a fiberizing apparatus. The molten glass exiting from the opening in the melter is intercepted and is prevented from free-falling into the body of glass in the bushing. The molten glass flow is supported from the melter to the bushing using a melter flow guide which is positioned between the melter and the bushing.

The foregoing and other objects, features, and advantages of the invention will appear more fully hereinafter from a consideration of the detailed description that follows, in conjunction with the accompanying sheets of drawings. It is to be expressly understood, however, that the drawings are for illustrative purposes and are not to be construed as defining the limits of the invention.

### BRIEF DESCRIPTION OF THE DRAWINGS

FIG. 1 is a perspective illustration of a portion of a glass melting system, partially broken away, showing a melter and a melter flow guide.

FIG. 2 is a cross-sectional view in elevation showing a melt flow guide positioned between a melter and a bushing.

FIG. 3 is a cross-sectional view showing another embodiment of a melt flow guide positioned between a melter and a bushing.

FIG. 4 is a cross-sectional view showing another embodiment of a melt flow guide positioned between a melter and a bushing.

FIG. 5 is a cross-sectional view showing another embodiment of a melt flow guide positioned between a melter and a bushing.

### DETAILED DESCRIPTION AND PREFERRED EMBODIMENTS

Unless defined otherwise, all technical and scientific terms used herein have the same meaning as commonly understood by one of ordinary skill in the art to which the invention belongs. Although any methods and materials similar or equivalent to those described herein can be used in the practice or testing of the present invention, the preferred methods and materials are described in this specification. It is to be noted that like numbers found throughout the figures refer to like elements.

A fiberizing system 10 typically includes at least one melter 12 where pre-refined glass (for example, glass marbles, not shown) is added to the melter 12. The pre-refined glass is heated to melting temperature by a suitable electrical resistance heating system 13 to form molten glass G.

In the embodiment shown the melter 12 is provided with electric terminals 13 for conducting electric current through the melter 12 to heat the glass. It is to be understood that any suitable heating system can be used to heat the glass. As the glass melts into molten glass G, the molten glass G is collected in a refining section 14 of the melter 12. That is, the molten glass G moves downward within the melter 12 into a refining section 14 and then is delivered to a bushing 20.

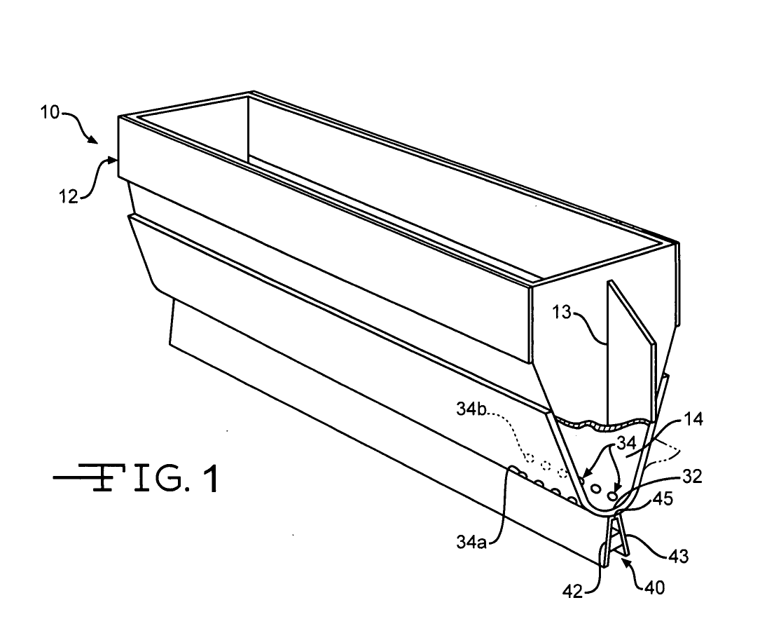

The melter 12 has a bottom surface 32 having a plurality of openings 34 through which the molten glass G flows as it passes from the melter 12 to the bushing 20. In the embodiment shown, the openings 34 are arranged in one or more rows, shown in FIGS. 1-2 and 4-5 as parallel extending rows 34a and 34b.

The molten glass G flows from the openings 34 in the melter 12 into the bushing 20. The bushing 20 has an opening 22 which is configured to receive the molten glass G from the melter 12. It will be appreciated that the selection of bushing shape and number of melters is for illustrative purposes only, it being understood that the feed bushing arrangement can be altered without any departure from the instant invention.

The molten glass G exits the bushing 20 through a bottom surface, or tip plate, 24 in the form of glass fibers or filaments 28. The tip plate 24 has a plurality of very small orifices 26 or tips through which the molten glass is pulled, or attenuated, into fibers 28.

A melter flow guide 40 is positioned below and adjacent to the melter 12. The melter flow guide 40 creates a substantially uniform flow of glass, referred to herein as a molten glass flow G_{f}, between the melter 12 and the bushing 20. In certain embodiments, the melter flow guide 40 may be constructed of a suitable conductive material which heats the molten glass flow G_{f} as electric current flows from the electric terminals 13. The molten glass flow G_{f} remains substantially uniformly heated as it flows from the melter 12 along the melter flow guide 40 into the bushing 20, as further explained below, although uniformity is not necessarily required.

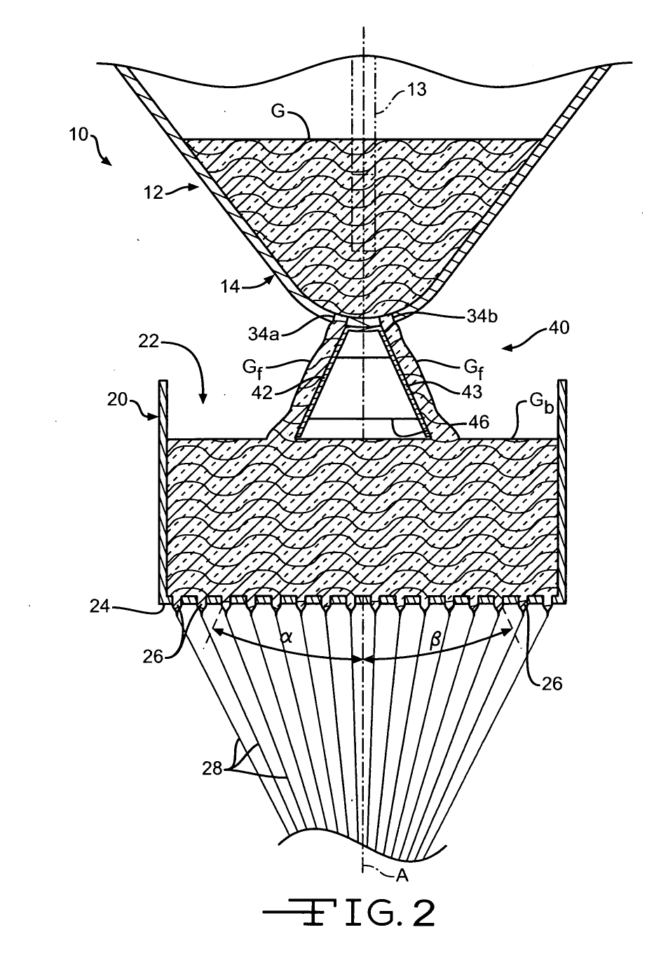

The melter flow guide 40 is positioned close to, or can be attached to, the bottom surface 32 of the melter 12. In the embodiment shown in FIGS. 1 and 2, the melter flow guide 40 is centrally displaced between the rows of openings 34a, 34b in the bottom surface 32 of the melter 12.

In one embodiment, the melter flow guide 40 may be generally formed in an inverted V-shape fashion. The melter flow guide 40 has a first guide wall 42 and a second guide wall 43 which have proximal ends at a base 45. The distal ends of the guide walls 42, 43 extend through the opening 22 of the bushing 20.

In certain embodiments, one or more support members 46 can extend between the guide walls 42, 43. The support member 46 provides a bracing to the guide walls 42, 43 as the molten glass flow G_{f} is directed into the bushing 20.

In certain embodiments, the first guide wall 42 is positioned at an acute angle a from vertical, as defined by the axis A in FIG. 2, and the second guide wall 43 is positioned at an acute angle β from vertical, as defined by the axis A in FIG. 2.

In certain embodiments, it is desired to have at least a slight incline, or acute angle α, to the first and second guide walls 42, 43. The first and second guide walls 42, 43 create a generally continuous path as the molten glass G exits the melter 12 as the molten glass flow G_{f}. The guide walls, 42, 43 direct the molten glass flow G_{f} into the bushing 20.

The glass fiberizing system 10 may be operated as follows. The melter 12 is generally operated at a controlled temperature by the application of suitable electric current through the melter 12, flow guide and bushing 20. It will be appreciated that the use of electric resistance heating of the melters and bushings is a conventional method used in the industry in the manufacture of fiber glass. Other heating methods can also be used.

Molten glass G is supplied from the melter 12 and discharged through the openings 34a, 34b in the bottom section 32 of the melter 12. The configuration of the guide walls 42, 43 of the melter flow guide 40 allows a continuous supply of the molten glass flow G_{f} to form between the molten glass G in the melter 12 and the molten glass body G_{b} in the bushing 20.

The guide walls 42, 43 thus direct the passage of molten flow glass G_{f} into the molten glass body G_{b} in the bushing 20. In the embodiment shown in FIG. 2, the molten glass flow G_{f} is directed by the guide walls 42, 43 of the melter flow guide 40 in a direction along the angles α and β. While the embodiment shown in FIG. 2 depicts the angles α and β as being equally distant at about 20° from the plane defined by the axis A, it should be understood that in other embodiments, the angles α and β can be at greater or lesser angles from the axis A and/or can be positioned at different angles from each other.

It is to be noted that the molten glass G in the melter 12, the molten glass flow G_{f} being directed along the melter flow guide 40, and the molten body of glass G_{b} in the bushing 20 are continuously connected with each other, thereby forming a continuous and uninterrupted flow of glass from the melter 12 into the bushing 20.

The guide walls 42, 43 of the melter flow guide 40 allow the glass to moving in a continuous manner so that the molten glass (G, G_{f} and G_{b}) flows without separating into discrete masses of glass into the bushing 20. The melter flow guide 40 prevents separate or disconnected drops of glass from free-falling or being released into the body of molten glass G_{b} in the bushing 20.

The guide walls 42, 43 allow the molten glass G from the melter 12 to flow in an uninterrupted course from the openings 34 in the melter 12 into the body of molten glass G_{b} in the bushing 20. The guide walls 42, 43 substantially support the molten glass flow G_{f} as it flows toward the bushing 20.

The guide walls 42, 43 intercept the molten glass G exiting from the openings 34, preventing the free-fall of the molten glass into the bushing 20. Thus, the molten glass (G, G_{f} and G_{b}) flows along the melter flow guide 40 in an uninterrupted manner from the melter 12 to the bushing 20. Since the molten glass flow G_{f} is supported by the melter flow guide 40, little or no air is entrained into the molten glass flow G_{f} as it enters and merges with the body of molten glass G_{b} in the bushing. The guide walls 42, 43 thus gently ease the molten glass flow G_{f} into the bushing, thereby reducing or preventing the formation of bubbles, or seeds.

The first and second guide walls 42, 43, according to the present invention, may be arranged in other configurations. For example, the guide walls 42, 43 may be formed without any base 45.

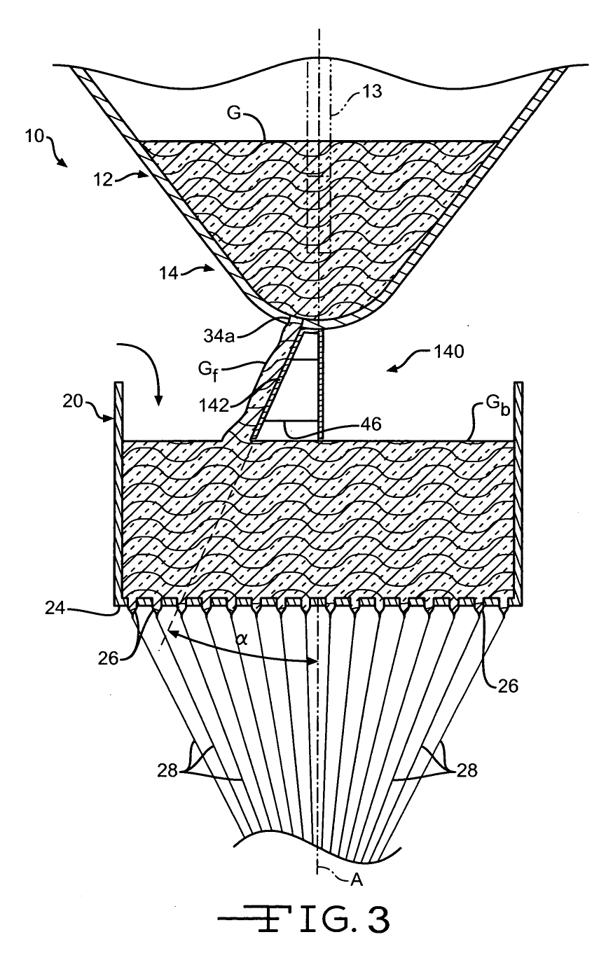

In another embodiment, as shown in FIG. 3, the fiberizing system 10 can have the openings 34a in the melter 12 adjacent to a melter flow guide 140 having one angled guide wall 142 which is positioned at an acute angle αfrom vertical, as defined by the axis A in FIG. 3.

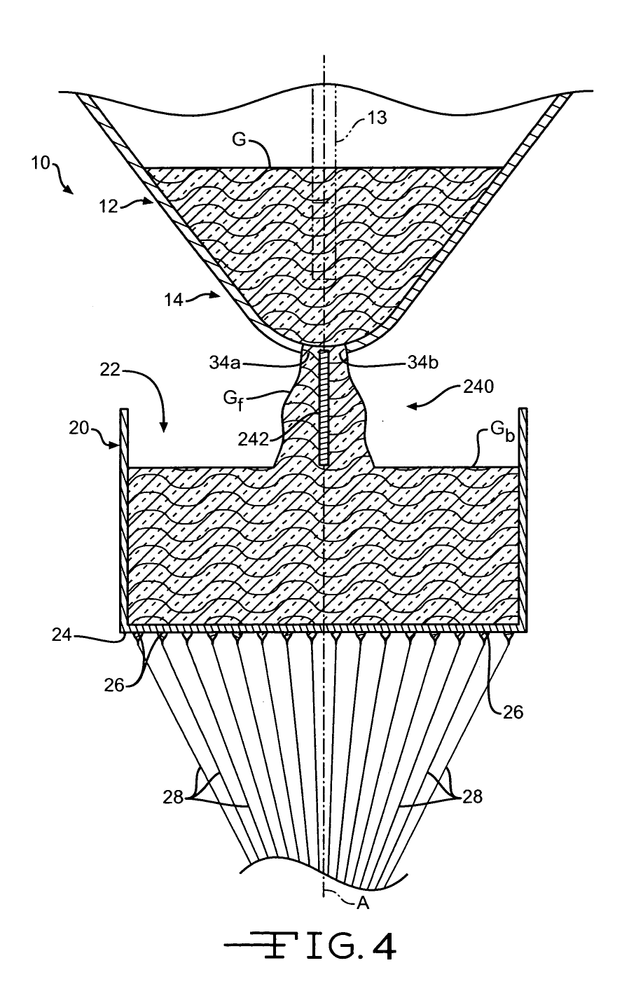

In another embodiment, as shown in FIG. 4, the fiberizing system 10 can have the openings 34a and 34b in the melter 12 adjacent to a melter flow guide 240 having one guide wall 242 which is positioned parallel to a vertical plane extending through the melter guide, as defined by the axis A in FIG. 4. The glass flow G_{f} can flow down both sides of the guide wall 242 without becoming discontinuous.

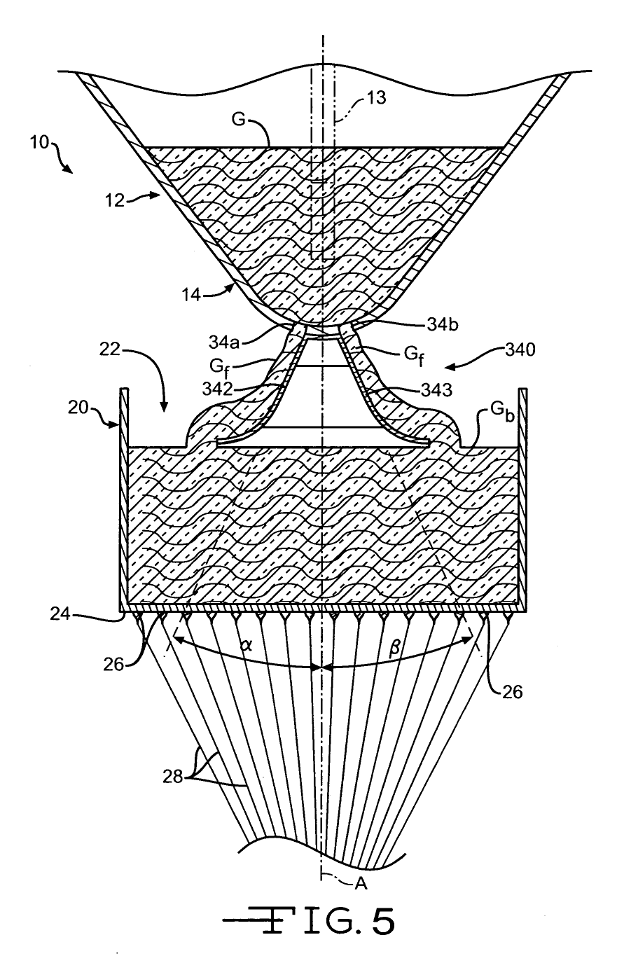

In another embodiment, as shown in FIG. 5, the fiberizing system 10 can have the openings 34a and 34b in the melter 12 adjacent to a melter flow guide 340 having first and second curved guide walls 342 and 343. The curved guide walls 342, 343 thus direct the passage of molten flow glass G_{f} into the molten glass body G_{b} in the bushing 20 along a gentle curved slope. In the embodiment shown in FIG. 5, the molten glass flow G_{f} is directed by the curved guide walls 442, 443 of the melter flow guide 40 along acute angles α and β. While the embodiment shown in FIG. 5 depicts the angles α and β as being equally distant from the plane defined by the axis A, it should be understood that in other embodiments, the angles α and β can be at greater or lesser angles from the axis A and/or can be positioned at different angles from each other.

It is to be noted that in the embodiment shown in FIG. 5, the molten glass flow G_{f} is directed along the melter flow guide 40 such that the molten glass flow G_{f} enters, or merges with, the molten body of glass G_{b} in the bushing 20 at a more horizontal direction than a vertical direction. The molten glass flow G_{f} remains continuously connected with the melter glass G and the body of molten glass G_{b}, thereby forming a continuous and uninterrupted flow of glass from the melter 12 into the bushing 20.

While the invention has been described with reference to various embodiments, it should be understood by those skilled in the art that various changes may be made and equivalents may be substituted for elements thereof without departing from the essential scope of the invention. In addition, many modifications may be made to adapt a particular situation or panel to the teachings of the invention without departing from the essential scope thereof. Therefore, it is intended that the invention not be limited to the particular embodiment disclosed as the best mode contemplated for carrying out this invention, but that the invention will include all embodiments falling within the scope of the claims.

What is claimed is:

1. A glass fiberizing system comprising:
a melter having a bottom wall with at least one opening through which molten glass flows;
a bushing located below the melter for containing a body of molten glass and for feeding molten glass to a fiberizing apparatus; and,
a melter flow guide positioned between the melter and the bushing, the melter flow guide having at least one guide wall,
the guide wall being positioned near the opening in the melter and extending to the body of molten glass in the bushing and configured to receive molten glass from the melter,
the guide wall intercepting the molten glass exiting from the opening and preventing a free-fall of the molten glass into the body of glass in the bushing.

2. The glass fiberizing system of claim 1, wherein the guide wall is configured to allow the molten glass from the melter to flow in an uninterrupted path from the opening in the melter into the body of molten glass in the bushing.

3. The glass fiberizing system of claim 1, wherein the melter flow guide has first and second guide walls oriented at acute angles with respect to a vertical plane.

4. The glass fiberizing system of claim 1, wherein the melter flow guide includes one or more angled guide walls oriented at an acute angle to a vertical plane and configured for supporting the molten glass from the melter opening, and configured for supplying a substantially continuous supply of molten glass from the melter to the body of molten glass in the bushing.

5. The glass fiberizing system of claim 1, wherein the melter flow guide comprises at least one curved guide wall.

6. The glass fiberizing system of claim 1, wherein the melter flow guide comprises opposing at least two opposing curved guide walls.

7. The glass fiberizing system of claim 1, wherein the melter flow guide comprises one guide wall positioned parallel to a vertical plane.

8. The glass fiberizing system of claim 1, wherein the guide wall is configured to minimize entrainment of air into the molten glass entering and merging with the body of molten glass in the bushing.

9. The glass fiberizing system of claim 1, wherein the guide wall is configured to ease the molten glass flow into the bushing, thereby reducing or preventing the formation of bubbles, or seeds.

10. The glass fiberizing system of claim 1, wherein the melter has two rows of openings on the bottom wall.

11. The fiberizing system of claim 1, wherein the first second guide wall is oriented at a first acute angle and the second guide wall is oriented at a second, different acute angle.

12. A method for forming glass fibers comprising:
melting glass in a melter having a bottom wall with at least one opening through which molten glass flows;
providing a bushing below the melter for containing a body of molten glass and for feeding molten glass to a fiberizing apparatus; and,
intercepting the molten glass exiting from the opening in the melter and preventing a free-fall of the molten glass into the body of glass in the bushing.

13. The method of claim 12, further including:
supporting the molten glass flow from the melter to the bushing using a melter flow guide positioned between the melter and the bushing,
the melter flow guide having at least one guide wall for receiving molten glass from the melter,
the guide wall being positioned near the opening in the melter, and extending to the body of molten glass in the bushing.

14. The method of claim 13, wherein the melter flow guide has first and second guide walls positioned at acute angles with respect to a vertical plane.

15. The method of claim 13, wherein the melter flow guide includes one or more angled guide walls oriented at an acute angle to a vertical plane and configured for supporting the molten glass from the melter opening, and configured for supplying a substantially continuous supply of molten glass from the melter to the body of molten glass in the bushing.

16. The method of claim 13, wherein the melter flow guide comprises a curved guide wall.

17. The method of claim 13, wherein the melter flow guide comprises two opposing two curved guide walls.

18. The method of claim 13, wherein the melter flow guide comprises one guide wall positioned parallel to a vertical plane.

19. The method of claim 13, wherein the guide wall minimizes entrainment of air into the molten glass entering and merging with the body of molten glass in the bushing.

20. The method of claim 14, wherein the first second guide wall is oriented at a first acute angle and the second guide wall is oriented at a second, different acute angle.
